(19) United States
(12) Patent Application Publication
(10) Pub. No.: US 2008/0293016 A1
(43) Pub. Date: Nov. 27, 2008

(54) TRY-IN IMPLANT WITH HANDLE

(75) Inventors: JOST LUSSI, ZURICH (CH); MIODRAG LAZIC, OBERDORF (CH)

Correspondence Address: RISSMAN JOBSE HENDRICKS & OLIVERIO, LLP, 100 Cambridge Street, Suite 2101, BOSTON, MA, 02114, US

(73) Assignee: STRAUMANN HOLDING AG, Basel (CH)

(21) Appl. No.: 12/123,676

(22) Filed: May 20, 2008

(30) Foreign Application Priority Data
May 21, 2007 (EP) EP 07010 035.9

(51) Int. Cl. A61C 13/36

(52) U.S. Cl. 433/196

(57) ABSTRACT

A try-in implant for verifying the position and angulation of a pilot hole and thereby providing a visual impression of the final implant position. The try-in implant comprises a body portion to be received in the pilot hole, a neck portion formed above the body portion, and an attachment portion formed above the neck portion. The attachment portion includes a handle to ensure easy and safe handling of the try-in implant.

### FIELD OF THE INVENTION

The present invention relates to a try-in implant for verifying the position and angulation of a pilot hole.

### BACKGROUND

When installing dental implants, the positioning of the implant is extremely important to obtain a good aesthetic and functional result. The positioning of the implant to a large extent determines the choice of prosthetic components. In order to provide guidance for the surgeon during the installation of an implant, various types of so-called surgical guide rails have traditionally been used. These guide rails are mainly produced under laboratory conditions and can be made in a number of different designs. As aids during the surgical intervention it is also possible to use so-called directional sensors.

U.S. Pat. No. 5,208,845 discloses a radiographic depth gauge for positioning dental implants in a jaw bone. The gauge is formed of a material, which is x-ray visible, and is an elongated member with distance markings. The gauge both shows the depth and angulation of the drill hole relative to other holes and existing dentition.

U.S. Pat. No. 5,842,859 discloses an indication device for marking and forming one or more attachment points for one or more fixtures, which can be fitted into a receiving hole in which it bears via a bearing part. At least one indicating part is interconnected with the protruding part and has a free end extending away from the existing hole, where a location of the new hole to be used as an attachment point is established at a position substantially adjacent to an exterior surface of the free end of the indicating part.

However, the devices known up to now have the disadvantage that the surgeon has no visual impression which indicates the implant's prosthetic portion, as well as the fact that they are difficult to handle due to their small size.

### SUMMARY OF THE INVENTION

The present invention provides a try-in implant which indicates the geometry of the implant's prosthetic portion and which is easy and safe to handle.

In one embodiment, the try-in implant comprises a body portion to be received in a pilot hole, a neck portion formed above said body portion, and an attachment portion formed above said neck portion. The attachment portion includes a handle to ensure easy and safe handling of said try-in implant.

The try-in implant according to various embodiments of the present invention fulfills the needs of the surgeon by ensuring a safe handling and allowing a direct visual impression of the situation during the early phase of implant surgery allowing adjustment of the position of the hole or selection of the correct implant system.

The try-in implant indicates the geometry of the implant's prosthetic portion. That means that it has the same shape as an implant (final implant) comprising an anchoring part with a threaded section, a neck portion as well as a mounting part. Due to the visual similarity of the try-in implant and the final implant, the surgeon has during the surgical intervention a visual impression of the situation after implantation which makes the decision, of which implant to select, easier. An implant to be chosen may be a one-part implant or a two-part implant, it may have a straight or angulated mounting part and the length and/or diameter of the implant to be selected may also be determined.

The facial-lingual, mesial-distal, corona-apical and apical-incisal position as well as the distance to adjacent teeth and implants can be verified with a try-in implant according to the present invention. Functional and aesthetic long-term results can be predicted due to the use of such a try-in implant.

The handle on the attachment portion ensures that the try-in implant can easily be inserted in the pilot hole, which means the first receiving hole or drill hole, by hand or by tweezers without being lost in the patient's mouth, thereby ensuring a safe handling.

In a preferred embodiment of the present invention the handle is attached on the top or on the side of the attachment portion. Depending on his preferences the surgeon may choose between try-in implants having the handle on the top or on the side of the attachment portion. Preferably the handle is on the side of the attachment portion, since this allows a better estimation of the correct height. Further also an occlusal control is possible.

In another preferred embodiment of the present invention the handle is an integral part of the attachment portion and at least a partly gripping surface of the attachment portion is provided to ensure that the try-in implant does not slip away during the handling procedure in the patient's mouth. Alternatively the attachment portion includes a suitable cavity to guarantee a safe handling of said try-in implant with an integrated handle. The cavity may vary in size and shape. For example it may be such that the gripping ends of a tweezers fit into the cavity. These two embodiments are especially preferred, since an integrated handle has no influence on the visual impression.

In another preferred embodiment of the present invention the handle comprises an opening. This opening allows for the secure retaining of the try-in implant, especially inside the patient's mouth, to prevent aspiration of the try-in implant. A thread or floss may be inserted through the opening and held outside a patient's mouth. In addition, the thread or floss can be used to assist in removing the try-in implant.

Depending on the pilot hole it may be necessary to select an implant with a straight or an angled abutment. Due to the fact that the try-in implant may have a straight or angled attachment portion, the surgeon may have a visual impression of both implant types. Therefore, the selection of the optimal implant is easier.

Preferably, the try-in implants have the same diameters as the drills. That means that they have diameters from 1.0 to 8.0 mm, preferably consisting of the group of 2.2 mm, 2.8 mm, 3.0 mm, 3.5 mm, 4.2 mm, 5 mm and 5.5 mm. Especially preferred are those having a diameter from 2.0 to 3.0 mm, for example 2.2 mm and 2.8 mm.

In order to predict the optimal length of the implant, the body of try-in implant may have different lengths, preferably a length of 6 mm to 8 mm. It is also possible that the try-in implants include a height indicator, designed with horizontal or lacuna markings. Such a height indicator makes it possible to decide whether an adjustment of the pilot hole is necessary, and which implant length should be chosen.

Preferably the try-in implants have, depending on their diameter and size, a specific color, which serves as a color code. Alternatively they have a tooth-like colour to support the visual impression.

In one embodiment of the present invention the try-in implant comprises mainly a metal selected from the group consisting of titanium, zirconium, and stainless steel; preferably the try-in implant is titanium or stainless steel. Alternatively the implants comprise an alloy of metals selected from the group consisting of cobalt, chromium, titanium, zirconium, niobium, hafnium and tantalum. Most preferred are 316 stainless steel, Ti6Al4V, Ti6Al7Nb and a Cr—Co alloy.

In another embodiment of the present invention the try-in implant is made of a synthetic material. The synthetic materials, is selected from the group consisting of ceramic, such as aluminium oxide or zirconium oxide, composite materials, as well as polymers, especially biocompatible USP Class 6 compliant polymers, such as PEEK (polyetheretherketone), POM (polyoxymethylene), Grilamid TR 70 LX of EMS, PEI of Sulzer Medica (polyethylene imine), PTFE (polytetrafluorethylene), PP (polypropylene), PMP (Polymethylpentene), PPSU (polyphenylsulfone), PE (polyethylene), and PC (polycarbonate). Preferably the implant is made of PEEK or POM.

Typically, a series of x-rays are taken in order to determine where and how to position the implants in the jaw bone without damaging surrounding structures such as the nerves in the lower jaw bone and the sinuses adjacent to the upper jaw bone. Based on said x-ray the pilot hole is drilled in the jaw bone. If, according to a further embodiment of the present invention, the try-in implant is made of a metal or synthetic material, which is X-ray visible, a further x-ray can be taken to determine the angulation of the pilot hole relative to existing dentition and the depth of the pilot hole relative to anatomical restriction. A possible synthetic material, which is X-ray visible, is BaSO₄ containing PEEK or ZrO₂ itself. X-ray visibility of the try-in implant permits optimal selection of the implant (one-part vs. two-part, straight or angled abutment as well as length of the implant) as well as the precision placement of implants to their maximum depth in the jaw bone to assure a maximum strength for supporting one or more dental restorations.

In one embodiment of the present invention the try-in implants can be sterilized and therefore be used several times. Alternatively, it is possible to produce the try-in implants made of a synthetic material as a single-use product guaranteeing a sterile product; this may be highly desired by consumers due to infection risks such as HIV or hepatitis.

### BRIEF DESCRIPTION OF THE DRAWINGS

The invention is explained below on the basis of figures and illustrative embodiments, without in any way limiting the invention to the embodiments shown. The drawings show the following:

FIG. 1 a one-part implant according to the state of the art;

FIG. 2 a side view of a first embodiment of a try-in implant according to the invention;

FIG. 3 a side view of an embodiment of a try-in implant according to the invention slightly modified with respect to the embodiment of FIG. 2;

FIG. 4 a side view of a further embodiment of a try-in implant according to the invention, wherein the handle is an integral part of the attachment portion;

FIG. 5 a side view of a further embodiment of a try-in implant according to the invention, wherein the attachment portion is angulated and the neck portion is anatomically shaped;

FIG. 6 a side view of a further embodiment of a try-in implant according to the invention with an opening to prevent aspiration of the try-in implant; and

FIG. 7 a side view of the embodiment shown in FIG. 6 with thread or floss through the opening.

### DETAILED DESCRIPTION

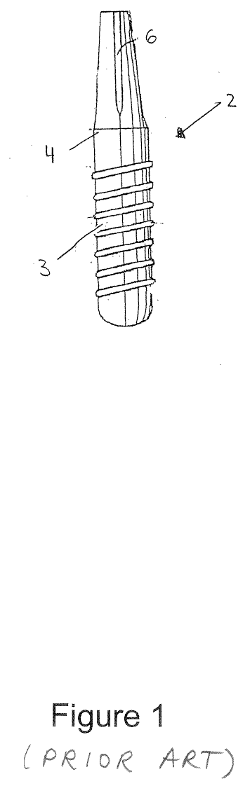

FIG. 1 shows one embodiment of a final implant in the form of a one-part implant 2 according to the state of the art. It comprises an anchoring part 3 with a threaded section, a neck part 4 and a mounting part 6.

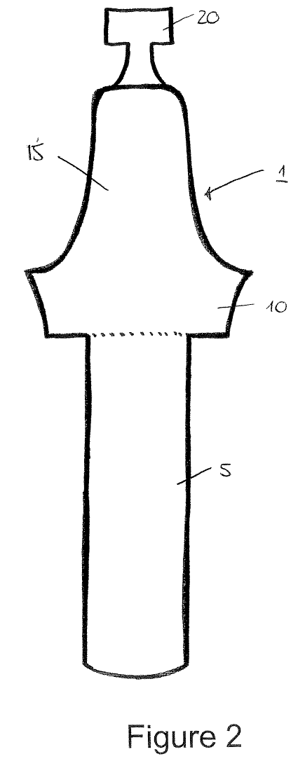

FIG. 2 shows a try-in implant 1 according to one embodiment of the present invention. The try-in implant 1 comprises a body portion 5 to be received in a pilot hole. The body portion 5 has a length of about 6 to 8 mm and corresponds to the drill hole and subsequently the anchoring part 3 of the final implant. At the upper end of the body portion 5 a neck portion 10 having a length of about 1 mm is formed which may comprise a slightly enlarged conical section. Above said neck portion 10 an attachment portion 15 having a length of about 1 to 6 mm is formed, which corresponds to the mounting part 6 of the final implant. The attachment portion 15 includes a handle 20 which ensures easy and safe handling of said try-in implant 1. The handle may have various forms, which can easily be gripped by hand or by tweezers, such as T-shape, triangular, rectangular, squarish or semicircular. Preferably the handle has a gripping surface. In the embodiment shown in FIG. 2 the handle 20 is mounted on the top of the attachment portion 15. The try-in implant 1 is made of a biocompatible metal or synthetic material as mentioned above. Preferably it is made of PEEK or POM.

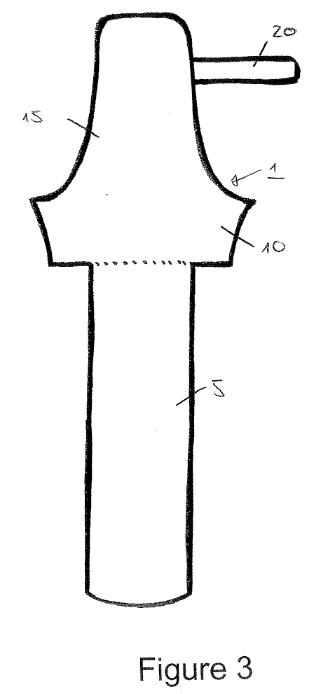

FIG. 3 shows a slightly modified embodiment of a try-in implant 1, which again comprises a body portion 5, a neck portion 10 and an attachment portion 15. The handle 20 is mounted on the side of the attachment portion 15.

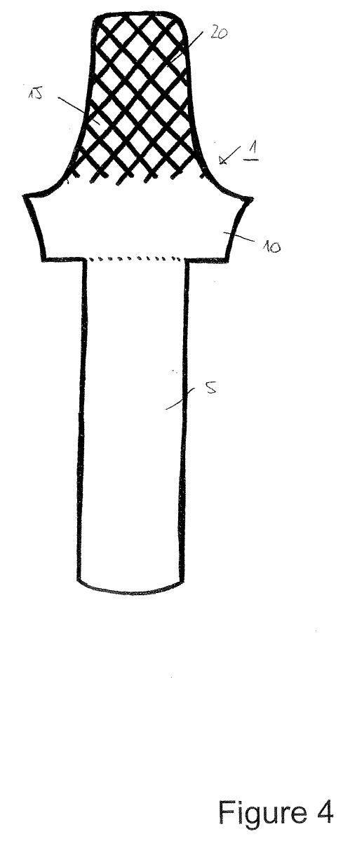

FIG. 4 shows a try-in implant 1 comprising a body portion 5, a neck portion 10 and an attachment portion 15. The handle 20 is an integral part of the attachment portion 15. In order to ensure an optimal gripping of the try-in implant 1, the integrated handle has a gripping surface (as shown by crosshatching).

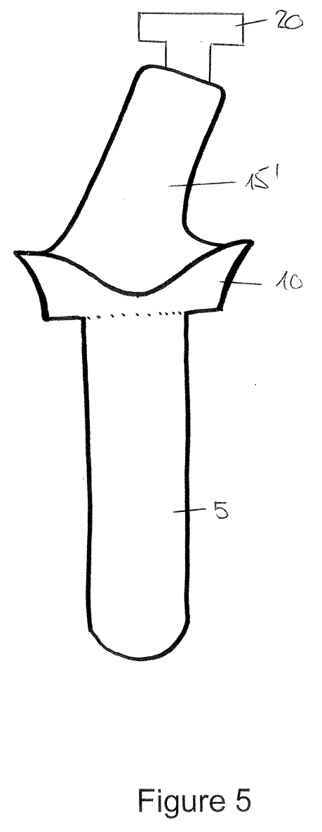

FIG. 5 shows, different from the embodiments shown in FIGS. 1 to 3, a try-in implant 1 with an angulated attachment portion 15′. Such a try-in implant 1 allows the surgeon to decide whether it is better to use an implant with a straight or angulated abutment.

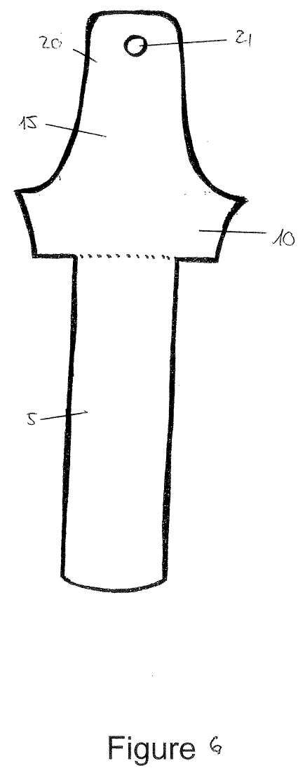

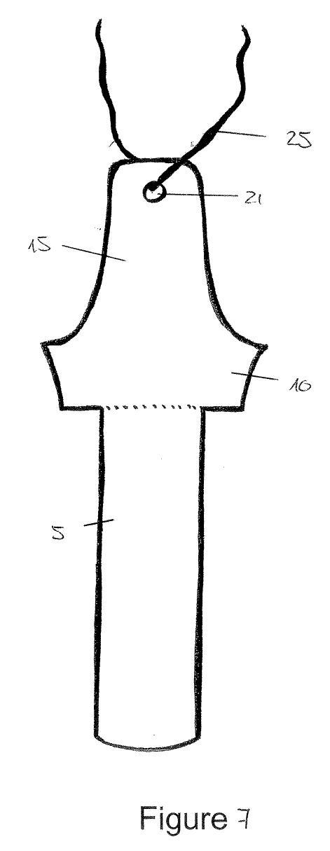

FIG. 6 shows a try-in implant 1, comprising a body portion 5, a neck portion 10 and an attachment portion 15. The handle 20 is an integral part of the attachment portion 15 and comprises an opening 21. This opening allows for the secure retaining of the try-in implant, especially inside the patient's mouth, to prevent aspiration of the try-in implant. A thread or floss 25, as shown in FIG. 7 may be inserted through the opening 21 and held outside the patient's mouth. Additionally, the thread or floss may be used to assist in removing the try-in implant in a safe and quick way.

1. Try-in implant for verifying a position and angulation of a pilot hole, said try-in implant comprising
a body portion to be received in said pilot hole, a neck portion formed above said body portion, and an attachment portion formed above said neck portion, said attachment portion including a handle,
wherein that the implant is made of a synthetic material selected from the group consisting of ceramic, composite materials, and polymers.

2. Try-in implant according to claim 1, wherein the handle is attached on the top of the attachment portion.

3. Try-in implant according to claim 1, wherein the handle is attached on the side of the attachment portion.

4. Try-in implant according to claim 1, wherein the attachment portion has a gripping surface.

5. Try-in implant according to claim 1, wherein the attachment portion includes a cavity.

6. Try-in implant according to claim 1, wherein the handle comprises an opening for the secure retaining of the try-in implant to prevent aspiration of the try-in implant.

7. Try-in implant according to claim 1, wherein the attachment portion is straight.

8. Try-in implant according to claim 1, wherein the body has a length of 6 to 8 mm.

9. Try-in implant according to claim 1, wherein the body portion includes height indicators.

10. Try-in implant according to claim 1, wherein the body portion has a diameter from 1.0 to 8 mm.

11. Try-in implant according to claim 1, wherein the implant is made of PEEK or POM.

12. Try-in implant according to claim 1, wherein the synthetic material is X-ray visible.

13. Try-in implant according to claim 1, wherein the try-in implant can be sterilized.

14. Try-in implant according to claim 1, wherein the try-in implant is a single use try-in implant.

15. Try-in implant according to claim 1, wherein the synthetic material is one or more polymers selected from the group consisting of PEEK, POM, Grilamid TR 70 LX, PEI, PTFE, PP, PMP, PPSU, PE, and PC.
